(19) United States
(12) Patent Application Publication
(10) Pub. No.: US 2025/0386767 A1
(43) Pub. Date: Dec. 25, 2025

(54) SUGARCANE BUTTLIFTER WITH SYNCHRONIZED PADDLES

(71) Applicant: DEERE & COMPANY, MOLINE, IL (US)

(72) Inventor: Michael L. Halbrook, Thibodaux, LA (US)

(21) Appl. No.: 18/747,610

(22) Filed: Jun. 19, 2024

(51) Int. Cl. A01D 57/22; A01D 45/10; A01D 69/06

(52) U.S. Cl. CPC A01D 57/22; A01D 45/10; A01D 69/06

(57) ABSTRACT

A buttlifter assembly for a sugarcane harvester includes an input that is rotatable about a central buttlifter axis. A paddle includes a first end and a second end, and extends therebetween along a central paddle axis. The paddle is operable to lift cut sugarcane stalks upward away from a ground surface and into a feed section of the sugarcane harvester. The buttlifter assembly includes a synchronizer assembly interconnecting the input and the paddle. The synchronizer assembly is configured for simultaneously rotating the paddle about the central paddle axis and the central buttlifter axis in response to the input rotating about the central buttlifter axis, whereby an orientation of the paddle relative to a vertical axis may be maintained during a lower half of a rotation cycle of the paddle about the central buttlifter axis.

### TECHNICAL FIELD

The disclosure generally relates to a buttlifter assembly for a sugarcane harvester.

### BACKGROUND

Sugarcane harvesters include a basecutter assembly positioned to sever sugarcane stalks adjacent a ground surface, and feed section that is adapted to receive a mat of severed sugarcane crop material from the basecutter assembly, and to move the mat of crop material rearwardly for further processing. The feed section may include, for example, successive pairs of upper and lower feed rollers rotatably supported by a support structure of the sugarcane harvester. At least one pair of the upper and lower feed rollers may be powered and counter-rotate relative to each other to transport the mat of the cut sugarcane crop material rearward.

The forwardmost lower feed roller of the feed section, i.e., the lower feed roller positioned directly behind the basecutter assembly, may be configured as and/or include a buttlifter assembly. The buttlifter assembly lifts the lower ends of the cut sugarcane stalks upward, away from the ground surface and into the feed section. In some implementations, in order to minimize collection of dirt, rocks and/or other debris with the cut sugarcane stalks, the buttlifter assembly may include a plurality of paddles spaced about a central buttlifter axis, and which rotate about the central buttlifter axis. The open paddle configuration provides openings between the paddles through which the dirt, rocks and/or other debris may fall out of the gathered sugarcane stalks, thereby reducing the amount of debris introduced into the feed section. These paddles may include a center portion that is positioned radially farther from the axis of rotation for lifting the sugarcane stalks into the feed section. However, when these paddles are disposed at the bottom half of their rotation cycle, i.e., near the ground surface, the center portion extends closer to the ground surface. The buttlifter assembly must therefore be positioned a sufficient distance away from the ground surface to avoid the paddles contacting the ground surface during the bottom half of the rotation cycle. Due to the geometry of the cutter discs of the basecutter assembly, it would be advantageous for cut quality and harvest efficiency to reduce the angular position of the basecutter assembly to be nearer horizontal. However, the height of the buttlifter assembly above the ground surface required to allow the paddles to rotate through the bottom half of their rotation cycle without contacting the ground surface limits a minimum angular position of the basecutter assembly.

### SUMMARY

A buttlifter assembly for a sugarcane harvester is provided. The buttlifter assembly includes an input that is rotatable about a central buttlifter axis. A paddle includes a first end and a second end. The paddle extends between the first end and the second end along a central paddle axis. The paddle is operable to lift cut sugarcane stalks upward away from a ground surface. A synchronizer assembly interconnects the input and the paddle. The synchronizer assembly is configured for simultaneously rotating the paddle about the central paddle axis and the central buttlifter axis while maintaining an orientation of the paddle relative to a constant datum, e.g., the ground surface, in response to the input rotating about the central buttlifter axis.

In one aspect of the disclosure, the synchronizer assembly may include a gear system that is operable to rotate the paddle about the central paddle axis according to a rotational position of the paddle about the central buttlifter axis.

In one implementation of the disclosure, the synchronizer assembly includes a planetary gear system having a sun gear, a ring gear, and a plurality of planet gears disposed in meshing engagement with both the sun gear and the ring gear. In one implementation, the input is attached to and rotatable with the sun gear, the paddle is attached to one of the plurality of planet gears, and the ring gear is rotatable about the central buttlifter axis. Rotation of the ring gear synchronized with the planet gears to synchronize movement of the paddles. In one implementation, an actuator, e.g., a belt drive system, a hydraulic motor, or an electric motor, may be coupled to the input for rotating the input and the sun gear. It should be appreciated that the components of the planetary gear system, i.e., the sun gear, the ring gear, and the planet gears may be connected to the input and the paddle in some other combination other than the example implementation of the planetary gear system described herein.

In one aspect of the disclosure, the paddle defines a side profile along the central paddle axis. The synchronizer assembly may be configured to rotate the paddle about the central paddle axis to maintain an orientation of the side profile relative to a vertical axis as the paddle rotes about the central buttlifter axis, whereby the orientation of the side profile relative to the vertical axis is synchronized relative to a rotational position of the input about the central buttlifter axis.

In one aspect of the disclosure, the central paddle axis extends through a geometric center of the first end and a geometric center of the second end. The side profile of the paddle may include a center portion, a first lateral side portion, and a second lateral side portion, with the center portion offset from the central paddle axis. The center portion is spaced farther from the central buttlifter axis when disposed above the central buttlifter axis relative to the ground surface than when disposed below the central buttlifter axis relative to the ground surface.

In one aspect of the disclosure, the synchronizer assembly may include an actuator operable to rotate the input about the central buttlifter axis. The actuator may include, but is not limited to, a hydraulic motor, and electric motor, a belt drive system, or some other rotational drive system.

In one aspect of the disclosure, the paddle is coupled to the input adjacent one of the first end of the paddle or the second end of the paddle. The paddle is offset from the central buttlifter axis. The central buttlifter axis is arranged substantially perpendicular to the central longitudinal harvester axis. The central paddle axis is parallel with the central buttlifter axis.

The buttlifter assembly, as described herein, may be incorporated into a sugarcane harvester. The sugarcane harvester includes a support structure defining a central longitudinal harvester axis. A basecutter assembly is coupled to the support structure and includes a cutting disc configured for severing sugarcane stalks adjacent a ground surface. The buttlifter assembly may be coupled to the support structure and positioned rearward of the basecutter assembly relative to a direction of travel while harvesting the sugarcane stalks. The buttlifter assembly is configured for lifting the severed sugarcane stalks upward away from the ground surface and into a feed section of the sugarcane harvester.

Accordingly, the synchronizer assembly described herein synchronizes the orientation of the paddle with the rotational position of the input to maintain the orientation of the paddle relative to the vertical axis by rotating the paddle about the central paddle axis as the paddle rotates about the central buttlifter axis. By doing so, the center portion of the profile of the paddle is disposed nearer the central buttlifter axis during the lower half of the rotation cycle about the central buttlifter axis, i.e., the portion of the rotation cycle that is closer to the ground surface. This in turn allows a feed section of the sugarcane harvester to be positioned nearer the ground surface without the paddles contacting the ground surface, which in turn allows the basecutter assembly to be positioned in a more horizontal orientation to improve cut quality and harvest efficiency.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic cross sectional side view of a sugarcane harvester.

FIG. 2 is a schematic perspective view of a buttlifter assembly of the sugarcane harvester.

FIG. 3 is a schematic cross sectional front view of the buttlifter assembly.

FIG. 4 is a schematic cross sectional side view of the buttlifter assembly.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

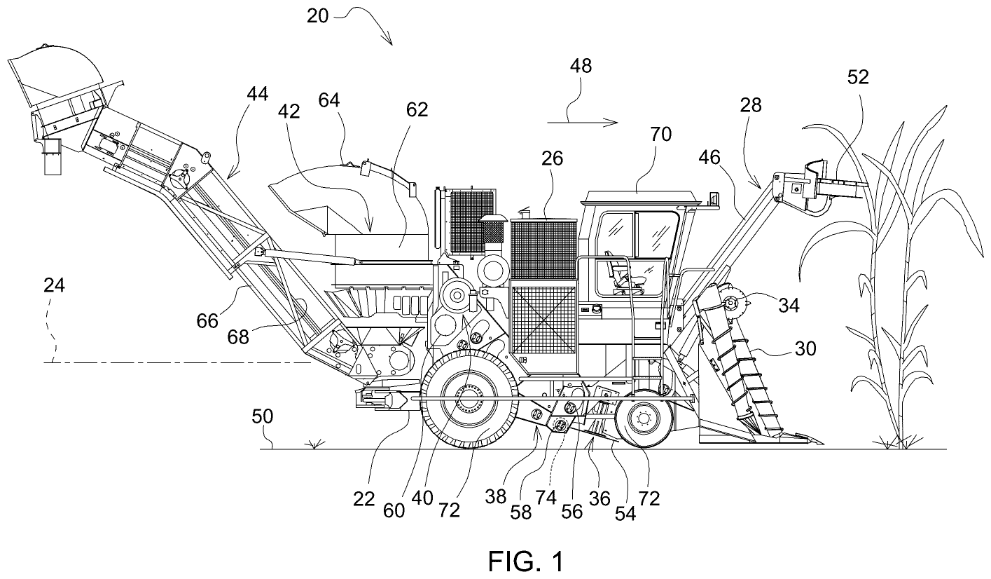

Referring to the Figures, wherein like numerals indicate like parts throughout the several views, a sugarcane harvester is generally shown at 20 in FIG. 1. Referring to FIG. 1, the sugarcane harvester 20 includes a support structure 22. The support structure 22 may alternatively be referred to as a main or primary frame of the sugarcane harvester 20. The support structure 22 defines a central longitudinal harvester axis 24 that extends between a forward end and a rearward end of the sugarcane harvester 20. The support structure 22 supports various cutting, routing and processing devices. An engine 26 may supply power for driving the sugarcane harvester 20 and for powering various driven components of the sugarcane harvester 20. In certain embodiments, the engine 26 may directly power a main hydraulic pump (not shown). Various driven components of the sugarcane harvester 20 may be powered by hydraulic motors receiving hydraulic power from the main hydraulic pump via one or more hydraulic loops (not shown).

Referring to FIG. 1, among other components and features, some of which are not described herein, the sugarcane harvester 20 may include a topper assembly 28, a left and a right crop divider scroll 30, an upper knockdown roller 34 and a lower knockdown roller (not shown), a basecutter assembly 36, a feed section 38, a chopping section or chopper 40, an extractor 42, and an elevator 44.

The topper assembly 28 is mounted to the support structure 22. The topper assembly 28 includes a cantilevered arm 46 attached to the support structure 22. The cantilevered arm 46 extends from the support structure 22 to a distal end thereof, in a generally forward direction relative to a direction of travel 48 during harvest operations, and a generally upward direction relative to a ground surface 50. The topper assembly 28 includes a top cutter 52 supported by the cantilevered arm 46 proximate the distal end of the cantilevered arm 46. The top cutter 52 is positioned for severing an upper leaf portion of a sugarcane plant from a central stalk portion of the sugarcane plant. The top cutter 52 may include a blade or other cutting device and/or system configured for cutting the sugarcane plant. The particular components, structure and operation of the top cutter 52 are understood by those skilled in the art, and are therefore not described in greater detail herein.

The left and right crop divider scrolls 30 are adapted to lift the sugarcane plants for feeding into a throat of the sugarcane harvester 20. The upper knockdown roller 34 and the lower knockdown roller are adapted to lean standing sugarcane plants in the forward direction relative to the direction of travel 48 of the sugarcane harvester 20 during operation.

The basecutter assembly 36 is mounted to the support structure 22 adjacent the ground surface 50. The basecutter assembly 36 includes one or more cutting discs 54 or some other cutting device that is configured for severing the sugarcane plants adjacent the ground surface 50. The basecutter assembly 36 is operable to sever a central stalk portion of the sugarcane plant from a bottom root portion of the sugarcane plant. The basecutter assembly 36 is adapted to sever the sugarcane plants knocked down or leaned over in the forward direction by the lower knockdown roller and the upper knockdown roller 34. Additionally, the basecutter assembly 36 is operable to move and/or feed the central stalk portion of the sugarcane plant to the feed section 38.

The feed section 38 is adapted to receive a mat of severed sugarcane crop material from the basecutter assembly 36, and to move the mat of crop material rearwardly for further processing. The feed section 38 may include, for example, successive pairs of feed rollers 56, 58, including an upper feed roller 56 and a lower feed roller 58, rotatably supported by the support structure 22. At least one pair of the feed rollers 56, 58 may be powered to transport the mat of the cut sugarcane crop material to the chopper 40. The chopper 40 is adapted to receive the mat from the feed section 38 and to cut the sugarcane plant into billets. The chopper 40 may include, for example, a drum 60 configured for cutting the stalks of sugarcane into billets.

The extractor 42 is positioned downstream from the chopper 40 and is adapted to separate debris, including, for example, crop residue (e.g., leafy material), from the billets and remove the debris from the sugarcane harvester 20. The extractor 42 includes a fan assembly 62 operable to induce a flow of air to extract the leaf material from the flow of billets produced by the chopper 40. A hood 64 is attached to the extractor 42. The hood 64 defines an exhaust outlet through which the leaf material is discharged from the extractor 42. The hood 64 may be moveable relative to the support structure 22 to position the exhaust outlet relative to the support structure 22 and the elevator 44. A rotator may be coupled to the hood 64 for rotating the hood 64 relative to the support structure 22 to direct discharge of the extracted leaf material from the exhaust outlet in a desired direction.

The billets are airborne when discharged from the chopper 40 facilitating separation of the leaf material from the billets by the flow of air induced by the extractor 42. Referring to FIG. 1, the elevator 44 is positioned at the rear of the sugarcane harvester 20 to receive the cleaned flow of billets from the chopper 40, and is adapted to convey the billets to an elevated position where the billets are discharged into a container or transport vehicle to be hauled away. The elevator 44 includes an elevator structure 66 that is attached to the support structure 22. The elevator structure 66 is attached to the support structure 22 proximate a lower end of the elevator structure 66, and extends upward and outward to a distal discharge end. The elevator 44 includes a conveyor 68 that is moveably supported on the elevator structure 66. The conveyor 68 may include, for example, but is not limited to an end endless belt or other similar structure. The conveyor 68 may include flighting or other similar structure to engage the billets and move the billets vertically upward. The conveyor 68 is operable to receive the billets from the chopper 40 and lift the billets to the distal discharge end of the elevator structure 66, whereby the billets are discharged from the elevator 44 into the transport vehicle.

Referring to FIG. 1, the sugarcane harvester 20 may include an operator station 70 and traction elements 72. The various user input and control devices, data output devices, etc., may be located within the operator station 70. A human operator may operate the sugarcane harvester 20 from the operator station 70. In certain embodiments, the support structure 22 may be supported by a transport frame such as track frame supporting the traction elements 72. The traction elements 72 are positioned on the left and right sides of the sugarcane harvester 20 for propelling the sugarcane harvester 20 through a field and along the ground surface 50. Each traction element may include, but is not limited to, a track unit or a ground-engaging wheel.

As described above, the feed section 38 is positioned immediately rearward of the basecutter assembly 36 for receiving the mat of sugarcane stalks from the basecutter assembly 36. The feed section 38 may include, for example, successive pairs of the upper feed rollers 56 and the lower feed rollers 58 rotatably supported by the support structure 22. A lowermost and forwardmost one of the lower feed rollers 58 of the feed section 38 may be implemented as a buttlifter assembly 74. In other implementations, the sugarcane harvester 20 may include the buttlifter assembly 74 positioned forward of the successive pairs of the upper feed rollers 56 and the lower feed rollers 58. The buttlifter assembly 74 is rotatably coupled to the support structure 22 and positioned rearward of the basecutter assembly 36 relative to the direction of travel 48 while harvesting the sugarcane stalks. The buttlifter assembly 74 is configured for lifting the severed sugarcane stalks upward away from the ground surface 50 and into the feed section 38, such that the mat of sugarcane stalks are positioned between the pairs of upper and lower feed rollers 58.

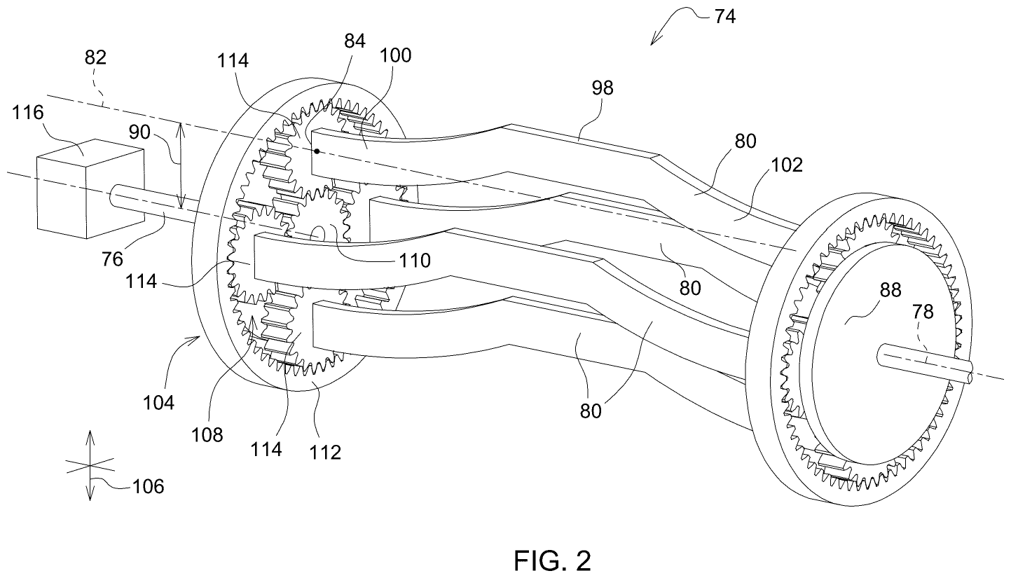

Referring to FIGS. 2-4, the buttlifter assembly 74 includes an input 76 that is rotatable about a central buttlifter axis 78, and a plurality of paddles 80 that are each rotatable about a respective central paddle axis 82. The input 76 may include, but is not limited to, a shaft or hub that is rotatably supported relative to the support structure 22 for rotation about the central buttlifter axis 78. The central buttlifter axis 78 is a longitudinal axis extending along a long dimension of the buttlifter assembly 74, and is arranged to be generally horizontal and perpendicular to the central longitudinal harvester axis 24 of the support structure 22. It should be appreciated that the input 76 may include several components combined together to form an assembly.

As noted above, the buttlifter assembly 74 may include a plurality of paddles 80. For convenience, only a single paddle 80 is described in detail below. It should be appreciated that the description of the paddle 80 below applies to all of the plurality of paddles 80 included in the buttlifter assembly 74.

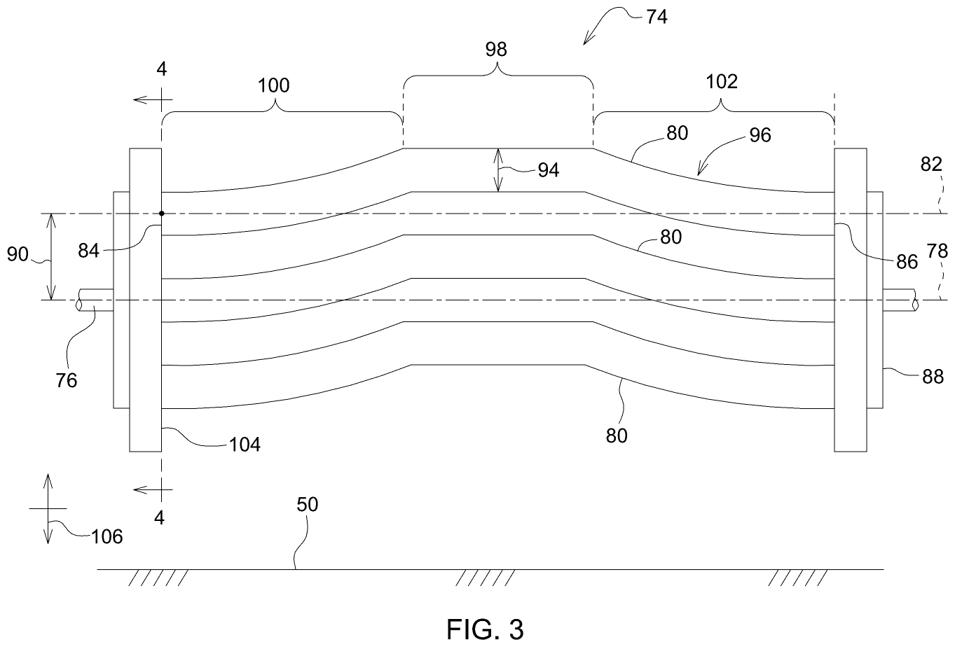

Referring to FIG. 3, the paddle 80 includes a first end 84 and a second end 86. The paddle 80 extends between the first end 84 and the second end 86 along the central paddle axis 82. The first end 84 and the second end 86 are each a longitudinal end of the paddle 80 along the central paddle axis 82. The central paddle axis 82 extends through a geometric center of the first end 84 and a geometric center of the second end 86. The paddle 80 is coupled to the input 76 adjacent and/or proximate one of the first end 84 of the paddle 80 or the second end 86 of the paddle 80. The other of the first end 84 and the second end 86 that is not coupled to the input 76 may be connected to a support system 88 operable to support the paddle 80 and maintain the orientation of the paddle 80 as described in greater detail below. The central paddle axis 82 is substantially parallel with the central buttlifter axis 78. As such, the paddle 80, and the central paddle axis 82 thereof, is laterally spaced away and offset from the central buttlifter axis 78 by a paddle offset distance 90.

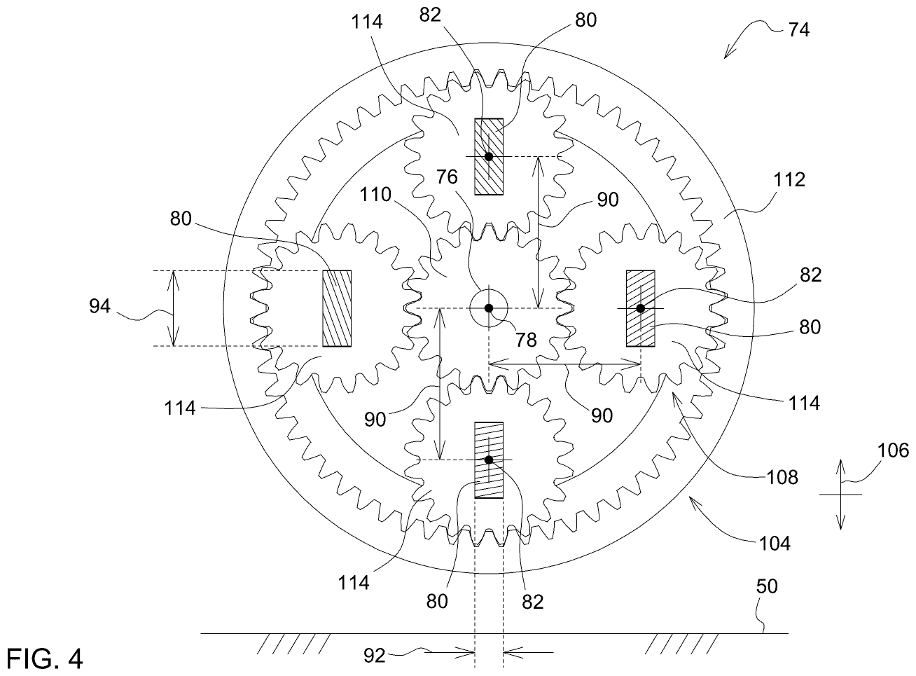

The paddle 80 is operable and configured to engage and lift cut sugarcane stalks upward away from the ground surface 50 and into the feed section 38 of the sugarcane harvester 20. Referring to FIGS. 3 and 4, the paddle 80 may include, but is not limited to, a generally flat, planar or plate like structure extending between the first end 84 and the second end 86. The plate like structure of the paddle 80 may include a thickness 92 measured in one dimension perpendicular to the central paddle axis 82, and a height 94 measured in a second dimension perpendicular to the central paddle axis 82. The height 94 of the paddle 80 may be greater than the thickness 92 of the paddle 80.

The paddle 80 defines a side profile 96 along the central paddle axis 82. In the example implementation best in the FIG. 3, the side profile 96 of the paddle 80 is generally defined by the height 94 of the plate like structure in the second dimension, between the first end 84 and the second end 86 of the paddle 80, relative to the central paddle axis 82. The side profile 96 of the paddle 80 includes a center portion 98, a first lateral side portion 100, and a second lateral side portion 102. The center portion 98 is disposed between the first lateral side portion 100 and the second lateral side portion 102. The center portion 98 is offset from the central paddle axis 82.

Referring to FIGS. 2-4, the buttlifter assembly 74 includes a synchronizer assembly 104 interconnecting the input 76 and the paddle 80. In response to the input 76 rotating about the central buttlifter axis 78, the synchronizer assembly 104 is configured for simultaneously rotating the paddle 80 about the central paddle axis 82 and the central buttlifter axis 78. The synchronizer assembly 104 is configured to rotate the paddle 80 about the central paddle axis 82 to maintain an orientation of the side profile 96 relative to a vertical axis 106 as the paddle 80 rotes about the central buttlifter axis 78, whereby the orientation of the side profile 96 relative to the vertical axis 106 is synchronized relative to a rotational position of the input 76 about the central buttlifter axis 78.

The synchronizer assembly 104 maintains the orientation of the paddle 80 as the paddle 80 rotates around the central buttlifter axis 78 such that the center portion 98 of the paddle 80 is spaced farther from the central buttlifter axis 78 when disposed above the central buttlifter axis 78 relative to the ground surface 50 than when disposed below the central buttlifter axis 78 relative to the ground surface 50. As such, when the paddle 80 is disposed directly above the central buttlifter axis 78, the center portion 98 of the paddle 80 extends radially outward and away from the central buttlifter axis 78, to properly position the sugarcane stalks in an entrance of the feed section 38. When the paddle 80 is disposed directly below the central buttlifter axis 78, the center portion 98 of the paddle 80 extends radially inward and toward the central buttlifter axis 78, to position the center portion 98 of the paddle 80 nearer the central buttlifter axis 78. This configuration enables the buttlifter assembly 74 and the feed section 38 to be positioned nearer the ground surface 50, which in turn enables the basecutter assembly 36 to be positioned closer to horizontal, improving cutting disc 54 operation.

In one example implementation, shown in the FIGS. 2 and 4, and described herein, the synchronizer assembly 104 may include a gear system 108 interconnecting the input 76 and the paddle 80. The gear system 108 may be configured and operable to rotate the paddle 80 about the central paddle axis 82 according to a rotational position of the paddle 80 about the central buttlifter axis 78 in order to maintain the orientation of the paddle 80 relative to the vertical axis 106 throughout the entire rotational cycle of the paddle 80 around the central buttlifter assembly 74.

For example, in the implementation shown in the FIGS. 2 and 4, the synchronizer assembly 104 includes a planetary gear system 108 having a sun gear 110, a ring gear 112, and a plurality of planet gears 114. The planet gears 114 may be attached to and/or disposed on a carrier as is understood by those skilled in the art. The planet gears 114 are disposed in meshing engagement with both the sun gear 110 and the ring gear 112. The input 76 is attached to and rotatable with the sun gear 110 for rotation about the central buttlifter axis 78. The paddle 80 is attached to one of the plurality of planet gears 114. It should be appreciated that each respective one of the plurality of paddles 80 is attached to a respective one of the plurality of planet gears 114. The ring gear 112 is rotatable about the central buttlifter axis 78. Rotation of the ring gear 112 may be synchronized with the planet gears 114 relative to rotation about the central buttlifter axis 78, to provide synchronized movement of the paddles 80. Rotation of the input 76 rotates the sun gear 110 about the central buttlifter axis 78. The sun gear 110 in turn engages and rotates each of the planet gears 114. With the ring gear 112 rotating with the planet gears 114 to maintain synchronization of the planet gears 114 as the planet gears 114 rotate about the central buttlifter axis 78. The planet gears 114 mesh with the ring gear 112 and move relative to the ring gear 112, causing the planet gears 114 to rotate about a respective center. As the planet gears 114 move relative to the ring gear 112, each of the planet gears 114 rotate about their respective center and also rotate about the center of the sun gear 110, i.e., the central buttlifter axis 78. The central paddle axis 82 of each respective paddle 80 may be aligned with the respective center of the planet gear 114 to which it is attached. As such, the paddles 80 rotate about their respective central paddle axis 82 as their respective planet gear 114 rotates about its center. Additionally, the paddles 80 rotate about the central buttlifter axis 78 as their respective planet gears 114 move around the ring gear 112. This coordinated and synchronized movement may be timed to maintain the orientation of the paddle 80 relative to the vertical axis 106 throughout the entire circular movement of the paddle 80 around the central buttlifter axis 78.

Referring to FIGS. 2 and 3, the synchronizer assembly 104 may further include an actuator 116 operable to rotate the input 76 about the central buttlifter axis 78. The actuator 116 may be directly or indirectly coupled to the input 76 for rotating the input 76 about the central buttlifter axis 78. In one example implementation described above, rotation of the input 76 with the actuator 116 rotates the sun gear 110 therewith, to thereby rotate the plurality of planet gears 114 and paddles 80 coupled thereto. The actuator 116 may include, but is not limited to, an electric motor, a hydraulic motor, a belt drive system that is powered by some other rotating member of the sugarcane harvester 20, etc.

It should be appreciated that the synchronizer assembly 104 may be configured and/or implemented differently than the described example implementation. For example, in other implementations not shown herein, if using a planetary gear system 108, the input 76 may be coupled to the ring gear 112. In other implementations, not shown herein, each respective one of the plurality of paddles 80 may have an associated actuator and dedicated gear system mounted on a carrier that is rotatable about the central buttlifter axis 78. The carrier may be driven to rotate about the central buttlifter axis 78, and the respective actuators of each respective paddle 80 may be driven to rotate the respective paddles 80 about their respective central paddle axis 82. As such, it should be appreciated that the synchronizer assembly 104 may be implemented in some other manner using other components not shown or described herein.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A buttlifter assembly for a sugarcane harvester, the buttlifter assembly comprising:
an input rotatable about a central buttlifter axis;
a paddle having a first end and a second end and extending between the first end and the second end along a central paddle axis, wherein the paddle is operable to lift cut sugarcane stalks upward away from a ground surface; and
a synchronizer assembly interconnecting the input and the paddle, wherein the synchronizer assembly is configured for simultaneously rotating the paddle about the central paddle axis and the central buttlifter axis in response to the input rotating about the central buttlifter axis.

2. The buttlifter assembly set forth in claim 1, wherein the synchronizer assembly includes a gear system operable to rotate the paddle about the central paddle axis according to a rotational position of the paddle about the central buttlifter axis.

3. The buttlifter assembly set forth in claim 1, wherein the synchronizer assembly includes a planetary gear system having a sun gear, a ring gear, and a plurality of planet gears disposed in meshing engagement with both the sun gear and the ring gear.

4. The buttlifter assembly set forth in claim 3, wherein the input is attached to and rotatable with the sun gear.

5. The buttlifter assembly set forth in claim 3, wherein the paddle is attached to one of the plurality of planet gears.

6. The buttlifter assembly set forth in claim 3, further comprising an actuator coupled to the input for rotating the input and the sun gear.

7. The buttlifter assembly set forth in claim 3, wherein the ring gear is rotatable about the central buttlifter axis.

8. The buttlifter assembly set forth in claim 1, wherein the paddle defines a side profile along the central paddle axis, and wherein the synchronizer assembly is configured to rotate the paddle about the central paddle axis to maintain an orientation of the side profile relative to a vertical axis as the paddle rotes about the central buttlifter axis, whereby the orientation of the side profile relative to the vertical axis is synchronized relative to a rotational position of the input about the central buttlifter axis.

9. The buttlifter assembly set forth in claim 8, wherein the central paddle axis extends through a geometric center of the first end and a geometric center of the second end.

10. The buttlifter assembly set forth in claim 9, wherein the side profile of the paddle includes a center portion, a first lateral side portion, and a second lateral side portion, with the center portion offset from the central paddle axis.

11. The buttlifter assembly set forth in claim 10, wherein the center portion is spaced farther from the central buttlifter axis when disposed above the central buttlifter axis relative to the ground surface than when disposed below the central buttlifter axis relative to the ground surface.

12. The buttlifter assembly set forth in claim 1, wherein the synchronizer assembly includes an actuator operable to rotate the input about the central buttlifter axis.

13. The buttlifter assembly set forth in claim 1, wherein the paddle is coupled to the input adjacent one of the first end of the paddle or the second end of the paddle.

14. The buttlifter assembly set forth in claim 1, wherein the paddle is offset from the central buttlifter axis.

15. The buttlifter assembly set forth in claim 1, wherein the central buttlifter axis is arranged substantially perpendicular to the central longitudinal harvester axis, and wherein the central paddle axis is parallel with the central buttlifter axis.

16. A sugarcane harvester comprising:
a support structure defining a central longitudinal harvester axis;
a basecutter assembly coupled to the support structure and having a cutting disc configured for severing sugarcane stalks adjacent a ground surface;
a buttlifter assembly coupled to the support structure and positioned rearward of the basecutter assembly relative to a direction of travel while harvesting the sugarcane stalks, wherein the buttlifter assembly is configured for lifting the severed sugarcane stalks upward away from the ground surface and includes:
an input rotatable about a central buttlifter axis;
a paddle having a first end and a second end and extending between the first end and the second end along a central paddle axis, wherein the paddle is operable to lift cut sugarcane stalks upward away from a ground surface; and
a synchronizer assembly including a gear system configured for simultaneously rotating the paddle about the central paddle axis and the central buttlifter axis in response to the input rotating about the central buttlifter axis.

17. The sugarcane harvester set forth in claim 16, wherein the paddle defines a side profile along the central paddle axis, and wherein the synchronizer assembly is configured to rotate the paddle about the central paddle axis to maintain an orientation of the side profile relative to a vertical axis as the paddle rotes about the central buttlifter axis, whereby the orientation of the side profile relative to the vertical axis is synchronized relative to a rotational position of the input about the central buttlifter axis.

18. The sugarcane harvester set forth in claim 16, wherein:
the central paddle axis extends through a geometric center of the first end and a geometric center of the second end;
the side profile of the paddle includes a center portion, a first lateral side portion,and a second lateral side portion, with the center portion offset from the central paddle axis; and
the center portion is spaced farther from the central buttlifter axis when disposed above the central buttlifter axis relative to the ground surface than when disposed below the central buttlifter axis relative to the ground surface.

19. The sugarcane harvester set forth in claim 16, wherein the gear system includes a planetary gear system having a sun gear, a ring gear, and a plurality of planet gears disposed in meshing engagement with both the sun gear and the ring gear.

20. The sugarcane harvester set forth in claim 19, wherein, the input is attached to and rotatable with the sun gear, the paddle is attached to one of the plurality of planet gears, and the ring gear is rotatable about the central buttlifter axis.
